(19) United States
(12) Patent Application Publication
(10) Pub. No.: US 2017/0053212 A1
(43) Pub. Date: Feb. 23, 2017

(54) DATA MANAGEMENT APPARATUS, DATA ANALYSIS APPARATUS, DATA ANALYSIS SYSTEM, AND ANALYSIS METHOD

(71) Applicant: NEC Corporation, Tokyo (JP)

(72) Inventor: Kazuyo NARITA, Tokyo (JP)

(73) Assignee: NEC Corporation, Tokyo (JP)

(21) Appl. No.: 15/119,070

(22) PCT Filed: Feb. 16, 2015
(86) PCT No.: PCT/JP2015/000688

§ 371 Date: Aug. 15, 2016

(30) Foreign Application Priority Data
Feb. 18, 2014 (JP) 2014-028454

(51) Int. Cl. G06N 99/00

(52) U.S. Cl. CPC G06N 99/005

(57) ABSTRACT

Even in circumstances where the size of training data is more than the memory size of a calculator, CD method can be used.

A data management apparatus (101) according to the present invention includes a blocking unit (20) which divides training data representing matrix data into a plurality of blocks, and generates meta data indicating a column for which each block holds a value of the original training data, and a re-blocking unit (40) which, when a component of a parameter learned from the training data converges to zero, replaces an old block including an unnecessary column, among the plurality of blocks, with a block from which the unnecessary column has been removed, and regenerates the meta data.

### TECHNICAL FIELD

The present invention relates to a data management apparatus, a data analysis apparatus, a data analysis system, and an analysis method for solving an optimization problem by using an optimization algorithm.

### BACKGROUND ART

Machine learning is used in the field of, e.g., data analysis and data mining. In methods such as logistic regression, SVM (Support Vector Machine), and the like in the machine learning, for example, when parameters are learned from training data (referred to as, for example, a design matrix, or a feature quantity), an objective function is defined. Then, the optimum parameter is learned by optimizing this objective function. The number of dimensions of such parameters may be too large to analyze the parameters manually. Therefore, a technique called sparse learning method (sparse regularization learning, lasso) is used. Here, “lasso” stands for least absolute shrinkage and selection operator. In sparse learning method, learning is performed so that values of the parameters for most of dimensions become zero in order to easily analyze the learning result. In the framework of the sparse learning method, most of components of the parameters converge to zero in the process of learning. The component that has converged to zero is disregarded as it is meaningless in terms of analysis.

In order to efficiently perform the machine learning, the improvement in efficiency of optimization problem is an essential issue. In a behavior recognition apparatus described in PTL 1, for matching of an operation feature quantity, minimums DR, C(X, Y) for a rotation matrix R and a corresponding matrix C are calculated by using Coordinate Descent method (hereinafter referred to as CD method). The CD method is one of methods for solving the optimization problem, and is an algorithm of a class called descent method.

Hereinafter, an effect of the CD method which is a type of optimization method called gradient method will be explained with reference to FIG. 15. FIG. 15 is a figure illustrating a movement of the CD method in a two-dimensional space. FIG. 15 schematically illustrates an effect of the CD method in the two-dimensional space. In the example of FIG. 15, the parameter w is a two-dimensional vector having a component w1 and a component w2 as elements. Multiple ellipses are contour lines indicating a combination of a component w1 and a component w2 where an objective function f(w) yields the same value. A star mark is a point where the objective function f(w) yields the minimum value or the maximum value, i.e., an objective solution w*. When the objective function f(w) is given, in accordance with the CD method, the point (objective solution) w* where f(w) is the minimum or the maximum is searched along each coordinate axis (each dimension) of the space of f(w). More specifically, the following processing is repeated after a start point (start in FIG. 15) for random search is determined. More specifically, a coordinate axis (dimension) j is selected, and a movement direction d and a movement width (step width) α of the search point are determined on the basis of the training data, and the component wj of the dimension j is updated with component wj+α·d (hereinafter referred to as Δ). In the following processing, another coordinate axis (dimension) is selected. This kind of processing is repeatedly performed on all the coordinate axes (dimensions) in order until the value of the objective function f(w) attains a value sufficiently closer to the objective solution w*.

As described above, when the objective function f(w) is given, the objective solution w* where the objective function f(w) yields the minimum or maximum value is searched along each coordinate axis of the space of f(w) in the CD method. Then, when a point sufficiently close to the objective solution w* is searched, the processing is stopped.

In the CD method, unlike Newton method, a high cost matrix operation is not required in the update calculation of the parameter, and thereby the calculation is performed at low cost. The CD method is based on a simple algorithm, and therefore the implementation can be done relatively easily. For this reason, many major methods of machine learning such as regression and SVM are implemented on the basis of the CD method.

### CITATION LIST

### Patent Literature

[PTL 1] Japanese Patent Application Laid-Open Publication No. 2006-340903

### SUMMARY OF INVENTION

### Technical Problem

However, the behavior recognition apparatus using the CD method described in PTL 1 has a problem in that, in a case where the size of the training data is more than the memory size of the calculator, it is impossible to read all the training data on the memory to apply the CD method.

In view of the above problem, it is an object of the present invention to provide a data management apparatus, a data analysis apparatus, a data analysis system, and a data analysis method capable of using CD method even in circumstances where the size of training data is more than the memory size of a calculator.

### Solution to Problem

A data management apparatus according to an exemplary aspect of the invention includes: a blocking means for dividing training data representing matrix data into a plurality of blocks, and generating meta data indicating a column for which each block holds a value of the original training data; and a re-blocking means for, when a component of a parameter learned from the training data converges to zero, replacing an old block including an unnecessary column, among the plurality of blocks, with a block from which the unnecessary column has been removed, and regenerating the meta data.

A data analysis apparatus according to an exemplary aspect of the invention includes: a queue management means for reading a predetermined block from among a plurality of blocks which are obtained by dividing training data representing matrix data, and storing the predetermined block to a queue; a repetition calculation means for reading the predetermined block stored in the queue, and carrying out repeated calculations according to a CD method; and a flag management means for, when a component of a parameter converges to zero during each of the repeated calculations, transmitting a flag indicating that a column of the training data corresponding to the component converged to zero can be removed.

A data analysis system according to an exemplary aspect of the invention includes: a blocking means for dividing training data representing matrix data into a plurality of blocks, and generating meta data indicating a column for which each block holds a value of the original training data; a re-blocking means for, when a component of a parameter learned from the training data converges to zero, replacing an old block including an unnecessary column, among the plurality of blocks, with a block from which the unnecessary column has been removed, and regenerating the meta data; a queue management means for reading a predetermined block from among the plurality of blocks which are obtained by dividing the training data representing matrix data, and storing the predetermined block to a queue; a repetition calculation means for reading the predetermined block stored in the queue, and carrying out repeated calculations according to a CD method; and a flag management means for, when a component of a parameter converges to zero during each of the repeated calculations, transmitting a flag indicating that a column of the training data corresponding to the component converged to zero can be removed.

A first computer readable storage medium according to an exemplary aspect of the invention records thereon a program, causing a computer to perform a method including: dividing training data representing matrix data into a plurality of blocks, and generating meta data indicating a column for which each block holds a value of the original training data; and when a component of a parameter learned from the training data converges to zero, replacing an old block including an unnecessary column, among the plurality of blocks, with a block from which the unnecessary column has been removed, and regenerating the meta data.

A second computer readable storage medium according to an exemplary aspect of the invention records thereon a program, causing a computer to perform a method including: reading a predetermined block from among a plurality of blocks which are obtained by dividing training data representing matrix data, and storing the predetermined block to a queue; reading the predetermined block stored in the queue, and carrying out repeated calculations according to a CD method; and when a component of a parameter converges to zero during each of the repeated calculations, transmitting a flag indicating that a column of the training data corresponding to the component converged to zero can be removed.

A data management method according to an exemplary aspect of the invention includes: dividing training data representing matrix data into a plurality of blocks, and generating meta data indicating a column for which each block holds a value of the original training data; and when a component of a parameter learned from the training data converges to zero, replacing an old block including an unnecessary column, among the plurality of blocks, with a block from which the unnecessary column has been removed, and regenerating the meta data.

A data analysis method according to an exemplary aspect of the invention includes: reading a predetermined block from among a plurality of blocks which are obtained by dividing training data representing matrix data, and storing the predetermined block to a queue; reading the predetermined block stored in the queue, and carrying out repeated calculations according to a CD method; and when a component of a parameter converges to zero during each of the repeated calculations, transmitting a flag indicating that a column of the training data corresponding to the component converged to zero can be removed.

An analysis method according to an exemplary aspect of the invention includes: dividing training data representing matrix data into a plurality of blocks, and generating meta data indicating a column for which each block holds a value of the original training data; when a component of a parameter learned from the training data converges to zero, replacing an old block including an unnecessary column, among the plurality of blocks, with a block from which the unnecessary column has been removed, and regenerating the meta data; reading a predetermined block from among the plurality of blocks which are obtained by dividing the training data representing matrix data, and storing the predetermined block to a queue; reading the predetermined block stored in the queue, and carrying out repeated calculations according to a CD method; and when a component of a parameter converges to zero during each of the repeated calculations, transmitting a flag indicating that a column of the training data corresponding to the component converged to zero can be removed.

### Advantageous Effects of Invention

An advantage of the present invention lies in that CD method can be used even in circumstances where the size of training data is more than the memory size of a calculator.

### BRIEF DESCRIPTION OF DRAWINGS

FIG. 1 is a block diagram illustrating a configuration of a data management apparatus 101 according to a first exemplary embodiment of the present invention.

FIG. 2 is a flow diagram illustrating an operation of the data management apparatus 101 according to the first exemplary embodiment of the present invention.

FIG. 3 is a block diagram illustrating a configuration of a data analysis apparatus 102 according to a second exemplary embodiment of the present invention.

FIG. 4 is a flow diagram illustrating an operation of the data analysis apparatus 102 according to the second exemplary embodiment of the present invention.

FIG. 5 is a block diagram illustrating a configuration of a data analysis system 103 according to a third exemplary embodiment of the present invention.

FIG. 6 is a block diagram illustrating an example of a computer achieving a configuration of the data analysis system 103 according to the third exemplary embodiment of the present invention.

FIG. 7 is a figure illustrating an example of training data and block division thereof according to the third exemplary embodiment of the present invention.

FIG. 8 is a figure illustrating an example of meta data according to the third exemplary embodiment of the present invention.

FIG. 9 is a flow diagram illustrating an operation of blocking according to the third exemplary embodiment of the present invention.

FIG. 10 is a flow diagram illustrating an operation of queue management according to the third exemplary embodiment of the present invention.

FIG. 11 is a flow diagram illustrating an operation of repeated calculations according to the third exemplary embodiment of the present invention.

FIG. 12 is a flow diagram illustrating an operation of flag management according to the third exemplary embodiment of the present invention.

FIG. 13 is a flow diagram illustrating an operation of re-blocking according to the third exemplary embodiment of the present invention.

FIG. 14 is a figure illustrating an example of new blocks and meta data generated in re-blocking according to the third exemplary embodiment of the present invention.

FIG. 15 is a figure illustrating an example of operation of Coordinate Descent method.

### DESCRIPTION OF EMBODIMENTS

### First Exemplary Embodiment

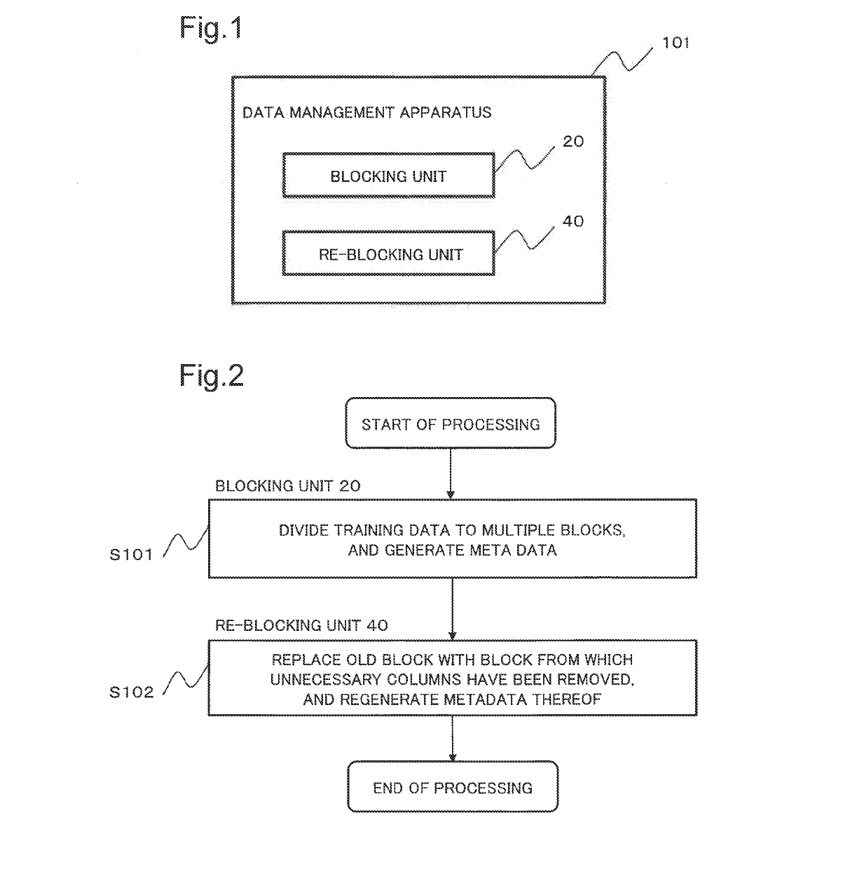

Exemplary embodiments of the present invention will be explained in details with reference to drawings. FIG. 1 is a block diagram illustrating a configuration of a data management apparatus 101 according to the first exemplary embodiment of the present invention.

The data management apparatus 101 according to the first exemplary embodiment of the present invention will be explained with reference to FIG. 1. It is noted that drawing reference signs given in FIG. 1 are added to the constituent elements for the sake of convenience as an example for helping understanding, and are not intended to give any kind of limitation to the present invention.

As illustrated in FIG. 1, the data management apparatus 101 according to the first exemplary embodiment of the present invention includes a blocking unit 20 and a re-blocking unit 40. The blocking unit 20 divides training data expressed as given matrix data (for example, a matrix having N rows and M columns expressed by integers N, M) into multiple blocks, and generates meta data which is information expressing the row and the column for which each block holds a value of the original training data. The re-blocking unit 40 monitors parameters learned from the training data. The parameters are components learned from the training data, and correspond to, for example, vector components of an objective function defined by CD method. When a component of the parameter (for example, a component wj of the j-th dimension (the j-th column of training data)) converges to zero in the learning processing of the training data, the re-blocking unit 40 replaces an old block which is one of blocks and which includes an unnecessary column with a block from which the unnecessary column has been removed. The unnecessary column is, for example, a column corresponding to an axis converging to zero. On the other hand, the block from which the unnecessary column has been removed may also be referred to as updated block. Then, the re-blocking unit 40 regenerates the meta data (information indicating the row and column for which each block holds the value of the original training data).

Subsequently, an operation of the data management apparatus 101 according to the first exemplary embodiment of the present invention will be explained with reference to FIG. 2.

FIG. 2 is a flow diagram illustrating an operation of the data management apparatus 101 according to the first exemplary embodiment of the present invention. It is noted that the flow diagram illustrated in FIG. 2 and the following explanation are an example of processing, and in accordance with required processing as necessary, the order of processing and the like may be switched, or the processing may be returned or repeated.

As illustrated in FIG. 2, the blocking unit 20 divides the training data representing given matrix data into multiple blocks, and generates meta data which is information indicating the row and column for which each block holds the value of the original data (step S101). When a component of the parameter learned from the training data converges to zero, the re-blocking unit 40 replaces an old block which is one of blocks and which includes an unnecessary column with a block from which the unnecessary column has been removed, and regenerates the meta data thereof (step S102).

The data management apparatus 101 according to the first exemplary embodiment of the present invention can use the CD method even in circumstances where the size of training data is more than the memory size of the data management apparatus or the calculator. This is because, by dividing the training data into blocks, the size of the data is reduced to the size of blocks, and even in a case where the training data is larger than the memory size, the processing according to the CD method can be performed in blocks that can be processed by the data management apparatus or calculator.

### Second Exemplary Embodiment

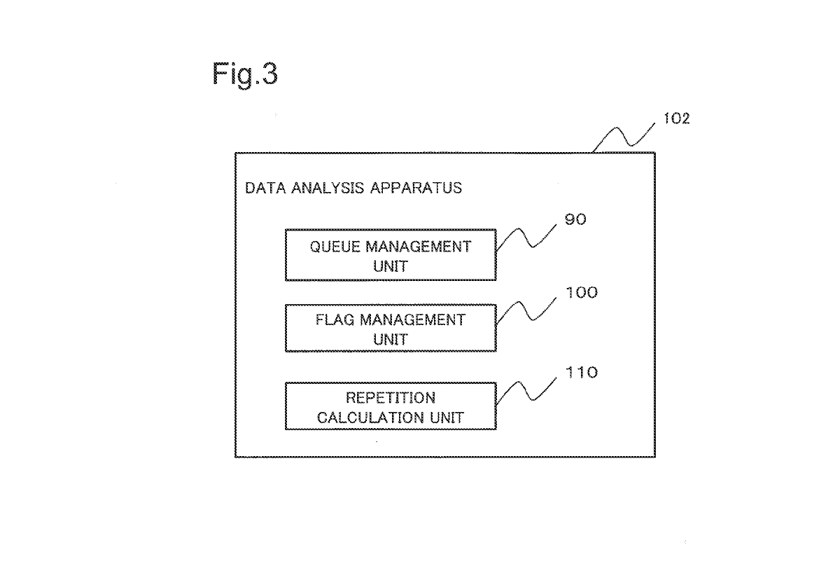

A configuration of a data analysis apparatus 102 according to the second exemplary embodiment for carrying out the present invention will be explained with reference to drawings. FIG. 3 is a block diagram illustrating a configuration of the data analysis apparatus 102 according to the second exemplary embodiment of the present invention.

As illustrated in FIG. 3, the data analysis apparatus 102 according to the second exemplary embodiment of the present invention includes a queue management unit 90, a repetition calculation unit 110, and a flag management unit 100.

The queue management unit 90 reads a predetermined block which is one of multiple blocks, i.e., data obtained by dividing training data represented by matrix data, and stores the predetermined block to a queue. The repetition calculation unit 110 carries out repeated calculations according to the CD method (corresponding to learning according to the first exemplary embodiment) while reading the predetermined block stored in the queue. When a component of the parameter converges to zero during each of the repeated calculations, the flag management unit 100 transmits a flag indicating that a column (of the training data) corresponding to the component can be removed.

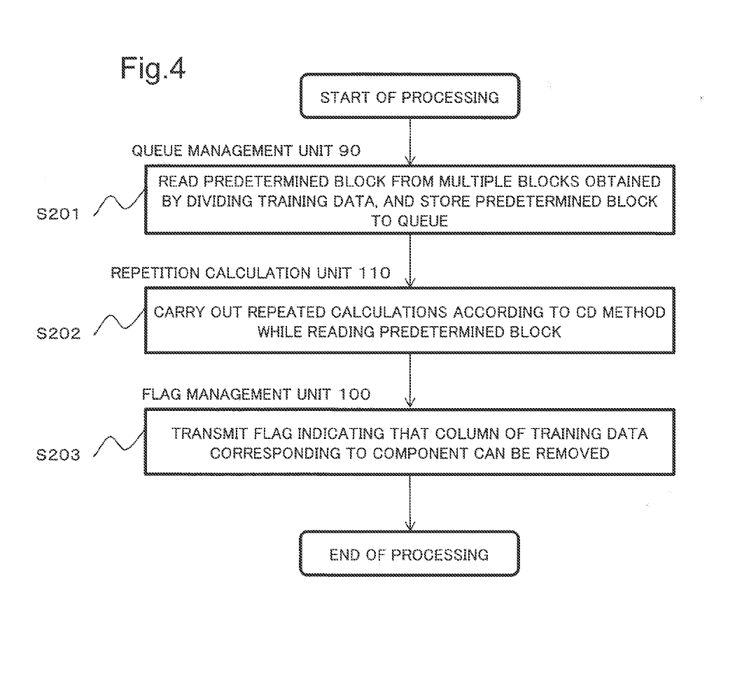

Subsequently, an operation of the data analysis apparatus 102 according to the second exemplary embodiment of the present invention will be explained with reference to FIG. 4.

FIG. 4 is a flow diagram illustrating an operation of the data analysis apparatus 102 according to the second exemplary embodiment of the present invention. As illustrated in FIG. 4, the queue management unit 90 reads a predetermined block which is one of multiple blocks, i.e., data obtained by dividing training data represented by given matrix data, and stores the predetermined block to a queue (step S201). The repetition calculation unit 110 carries out the repeated calculations according to the CD method while reading the predetermined block stored in the queue (step S202). When a component of the parameter converges to zero during each of the repeated calculations, the flag management unit 100 transmits a flag indicating that a column of the training data corresponding to the component can be removed (step S203).

The data analysis apparatus 102 according to the second exemplary embodiment of the present invention can use the CD method even in circumstances where the size of training data is more than the memory size of the calculator. This is because, by dividing the training data into blocks, the size of the data is reduced to the size of blocks, and even in a case where the training data is larger than the memory size, the processing according to the CD method can be performed in blocks.

### Third Exemplary Embodiment

First, problems to be solved in exemplary embodiments of the present invention will be clarified.

There is a problem (first problem) in that, in a case where the size of the training data is more than the memory size of the calculator, the behavior recognition apparatus using the CD method described in PTL 1 cannot read all the training data to the memory and apply the CD method. With the recent advancement in information techniques, an enormous amount of training data beyond the memory size of the machine can be easily obtained, and therefore, the training data cannot be placed in the memory, which makes it impossible to execute the processing according to the CD method in many cases.

Further, in the behavior recognition apparatus using the CD method described in PTL 1, there is a problem (second problem) in that the calculation to be repeated occurs multiple times in the CD method, which increases the processing time. In the CD method, it is necessary to refer to each row of the training data in a single update. In particular, when facing with the first problem, it is necessary to employ, as a countermeasure, an Out-of-Core solution to read as much training data as possible to the memory, process the training data, and then read subsequent portion of the training data. At this occasion, reading of data frequently occurs, and this excessively increases the processing time.

The data analysis system 103 according to the third exemplary embodiment for carrying out the present invention solves the first problem and the second problem. Hereinafter, a configuration and an operation of the data analysis system 103 according to the third exemplary embodiment for carrying out the present invention will be explained.

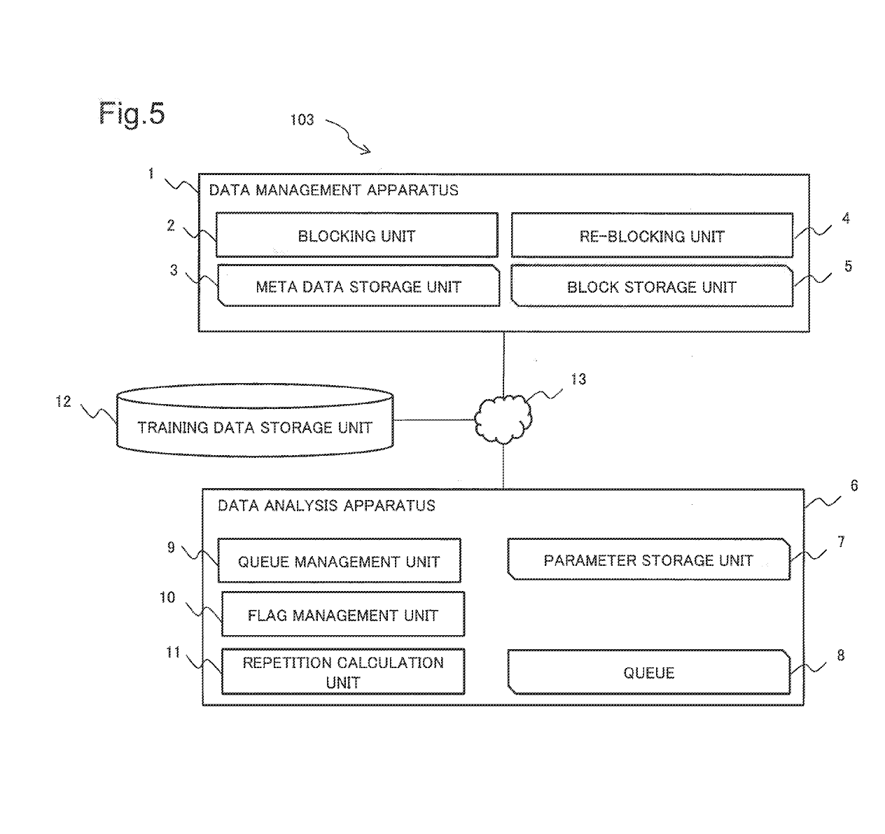

First, a configuration of the data analysis system 103 according to the third exemplary embodiment for carrying out the present invention will be explained with reference to drawings. FIG. 5 is a block diagram illustrating a configuration of the data analysis system 103 according to the third exemplary embodiment of the present invention.

The data analysis system 103 according to the third exemplary embodiment of the present invention includes a data management apparatus 1, a data analysis apparatus 6, and a training data storage unit 12. The data management apparatus 1, the data analysis apparatus 6, and the training data storage unit 12 are communicatively connected by a network 13, a bus, and the like. The training data storage unit 12 stores the training data. For example, the training data storage unit 12 may serve as a storage device provided outside of the data analysis system 103 to store training data. In this case, the data analysis system 103 and the storage device thereof are connected communicatively via the network 13, and the like.

The data management apparatus 1 includes a blocking unit 2, a meta data storage unit 3, a re-blocking unit 4, and a block storage unit 5. The blocking unit 2 and the re-blocking unit 4 have the same configurations and functions as those of the blocking unit 20 and the re-blocking unit 40 included in the data management apparatus 101 according to the first exemplary embodiment of the present invention explained above.

The blocking unit 2 reads the training data stored (given) in the training data storage unit 12, and divides the training data into multiple blocks. Further, the blocking unit 2 stores data of divided blocks to the block storage unit 5. The blocking unit 2 generates meta data indicating the row and column for which each block holds the value of the original training data, and stores the meta data to the meta data storage unit 3.

The block storage unit 5 stores the data of each block of the training data thus divided. The meta data storage unit 3 stores the meta data generated by the blocking unit 2.

When a component of the parameter learned from the training data converges to zero, the re-blocking unit 4 replaces an old block which is one of blocks and which includes an unnecessary column with a block from which the unnecessary column has been removed, and regenerates the meta data for the replaced block.

The data analysis apparatus 6 includes a parameter storage unit 7, a queue 8, a queue management unit 9, a flag management unit 10, and a repetition calculation unit 11. The queue management unit 9, the repetition calculation unit 11, and the flag management unit 10 have the same configurations and functions as those of the queue management unit 90, the repetition calculation unit 110, and the flag management unit 100 included in the data analysis apparatus 102 according to the second exemplary embodiment of the present invention.

The parameter storage unit 7 stores a variable, which is to be updated, such as a parameter. The queue 8 stores a block.

The repetition calculation unit 11 reads, from the queue 8, a block or a representing value required for a column to be calculated by the repetition calculation unit 11, and performs update calculation. The repetition calculation unit 11 carries out repeated calculations according to the CD method while reading a predetermined block stored in the queue 8. The repetition calculation unit 11 determines whether each component of the parameter converges to zero or not for each of the repeated calculations. In a case where there is a component wj converging to zero, the repetition calculation unit 11 calls the flag management unit 10 and sends information indicating that the component wj has converged to zero.

The queue management unit 9 discards an unnecessary block from the queue 8, and obtains (for example, fetches) a newly required block from the block storage unit 5. The flag management unit 10 receives information indicating that the component wj has converged to zero from the repetition calculation unit 11, and outputs the unnecessary column to the data management apparatus 1.

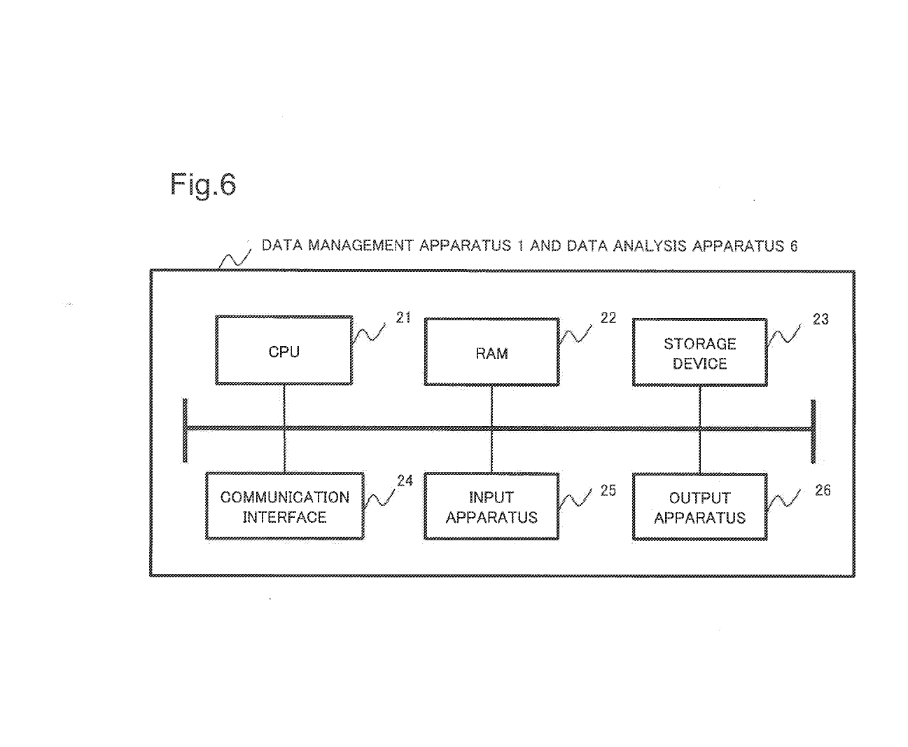

A computer achieving the data management apparatus 1 and the data analysis apparatus 6 included in the data analysis system 103 according to the third exemplary embodiment of the present invention will be explained with reference to FIG. 6.

FIG. 6 is a typical hardware configuration diagram illustrating the data management apparatus 1 and the data analysis apparatus 6 included in the data analysis system 103 according to the third exemplary embodiment of the present invention. As illustrated in FIG. 6, each of the data management apparatus 1 and the data analysis apparatus 6 includes, for example, a CPU (Central Processing Unit) 21, a RAM (Random Access Memory) 22, and a storage device 23. Each of the data management apparatus 1 and the data analysis apparatus 6 includes, for example, a communication interface 24, an input apparatus 25, and an output apparatus 26.

The blocking unit 2 and the re-blocking unit 4 included in the data management apparatus 1, and the queue management unit 9, the flag management unit 10, and the repetition calculation unit 11 included in the data analysis apparatus 6 are achieved by the CPU 21 reading a program to the RAM 22 and executing the program. The meta data storage unit 3 and the block storage unit 5 included in the data management apparatus 1, and the parameter storage unit 7 and the queue 8 included in the data analysis apparatus 6 are, for example, a hard disk and a flash memory.

The communication interface 24 is connected to the CPU 21, and is connected to a network or an external storage medium. External data may be retrieved to the CPU 21 via the communication interface 24. The input apparatus 25 is, for example, a keyboard, a mouse, and a touch panel. The output apparatus 26 is, for example, a display. A hardware configuration as illustrated in FIG. 6 is merely an example, and may be configured as a logic circuit in which constituent elements of the data management apparatus 1 and the data analysis apparatus 6 are independent from each other.

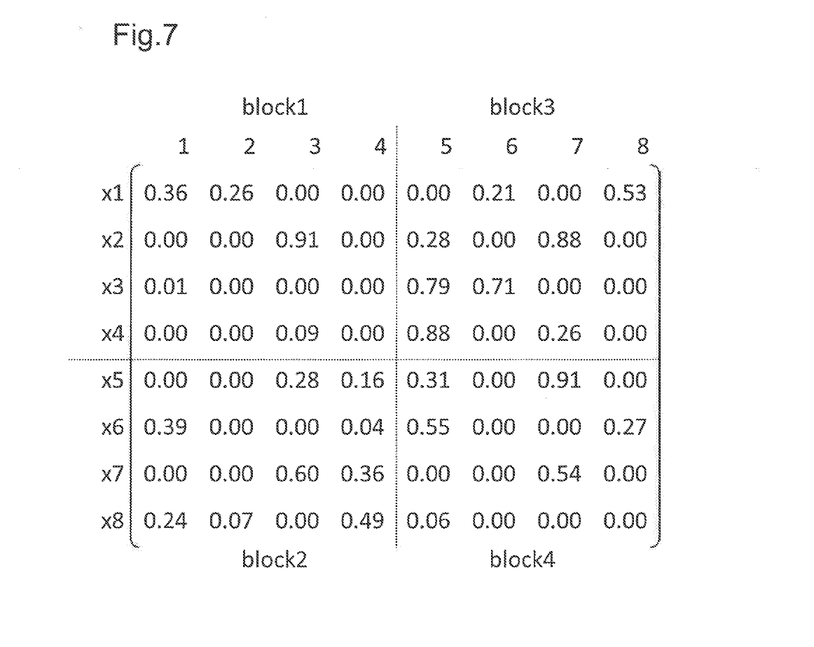

Subsequently, an operation of the data analysis system 103 according to the third exemplary embodiment of the present invention will be explained with reference to FIGS. 7 to 14.

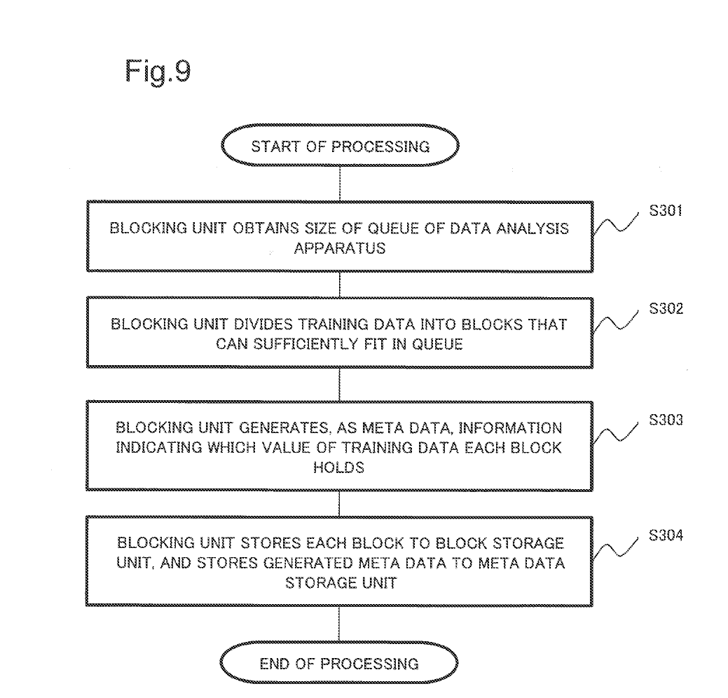

FIG. 9 is a flow diagram (flowchart) illustrating an operation of the blocking unit 2 according to the third exemplary embodiment of the present invention. First, the blocking unit 2 obtains the size of the queue 8 of the data analysis apparatus 6 (step S301). Subsequently, the blocking unit 2 divides the training data into blocks having a size small enough to fit in the queue 8 (step S302). The method for dividing the training data may include, for example, dividing in a row direction, dividing in a column direction, or dividing in both directions of the matrix.

Subsequently, the blocking unit 2 generates, as meta data, information indicating which value of the training data each block holds (step S303). Then, the blocking unit 2 stores the data of each block to the block storage unit 5, and stores the generated meta data to the meta data storage unit 3 (step S304).

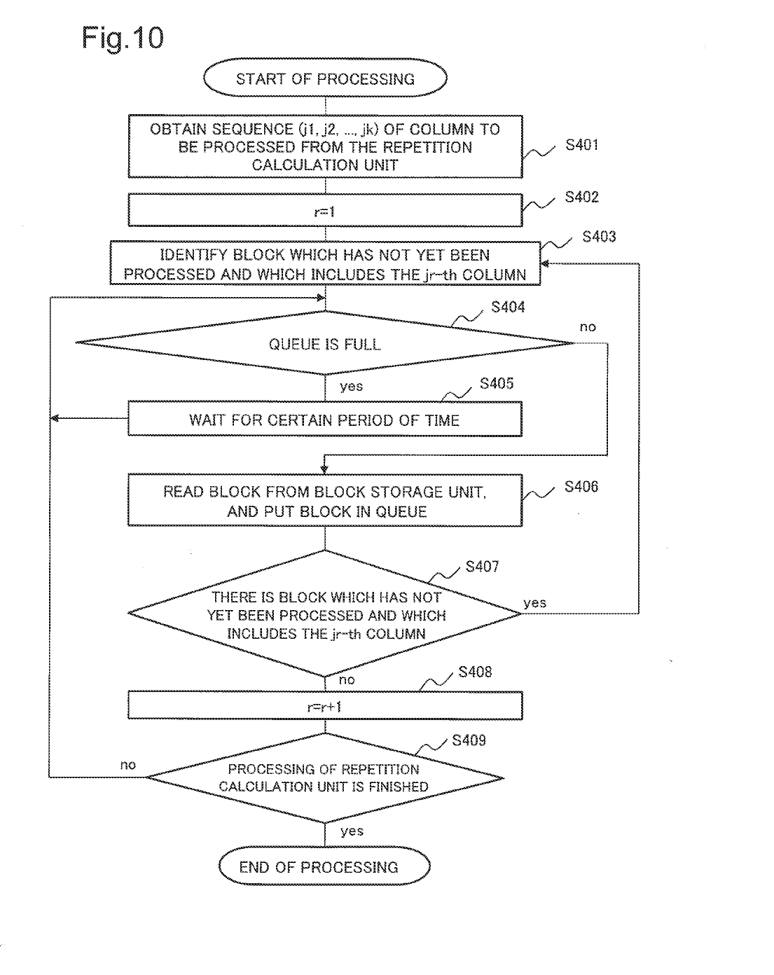

FIG. 10 is a flow diagram illustrating an operation of the queue management unit 9 according to the third exemplary embodiment of the present invention. First, the queue management unit 9 obtains a sequence (j1, j2, . . . , jk) of a column to be processed from the repetition calculation unit 11 (step S401). Here, k is an integer equal to or more than one. An order relationship of the sequence of the column to be processed may be a descending order or an ascending order of a column number, or may be random, or may be in an order relationship other than the above. Subsequently, the queue management unit 9 initializes a counter r with one (step S402). Here, the value of the counter r may be one to k. The queue management unit 9 refers to the meta data stored in the meta data storage unit 3 to identify a block stored in the block storage unit 5, which has not yet been processed and which includes the jr-th column (step S403).

Subsequently, in a case where the queue 8 is full (YES in step S404), the queue management unit 9 waits while checking the queue 8 with a regular interval until there is a vacancy (step S405). In a case where there is a vacancy in the queue 8 (No in step S404), the queue management unit 9 reads the block from the block storage unit 5, and puts the block into the queue 8 (step S406). In a case where there is another block which has not yet been processed and which includes the jr-th column (YES in step S407), the above processing is repeated (returning back to step S403). In a case where there is not any block which has not yet been processed and which includes the jr-th column (No in step S407), the queue management unit 9 updates the value of the counter r (step S408). For example, the queue management unit 9 adds one to the value of the counter r. Then, in a case where the processing of the repetition calculation unit 11 is finished (YES in step S409), the processing of the queue management unit 9 is terminated. In a case where the processing of the repetition calculation unit 11 is not finished (No in step S409), the above processing is repeated until the processing is finished (returning back to step S404).

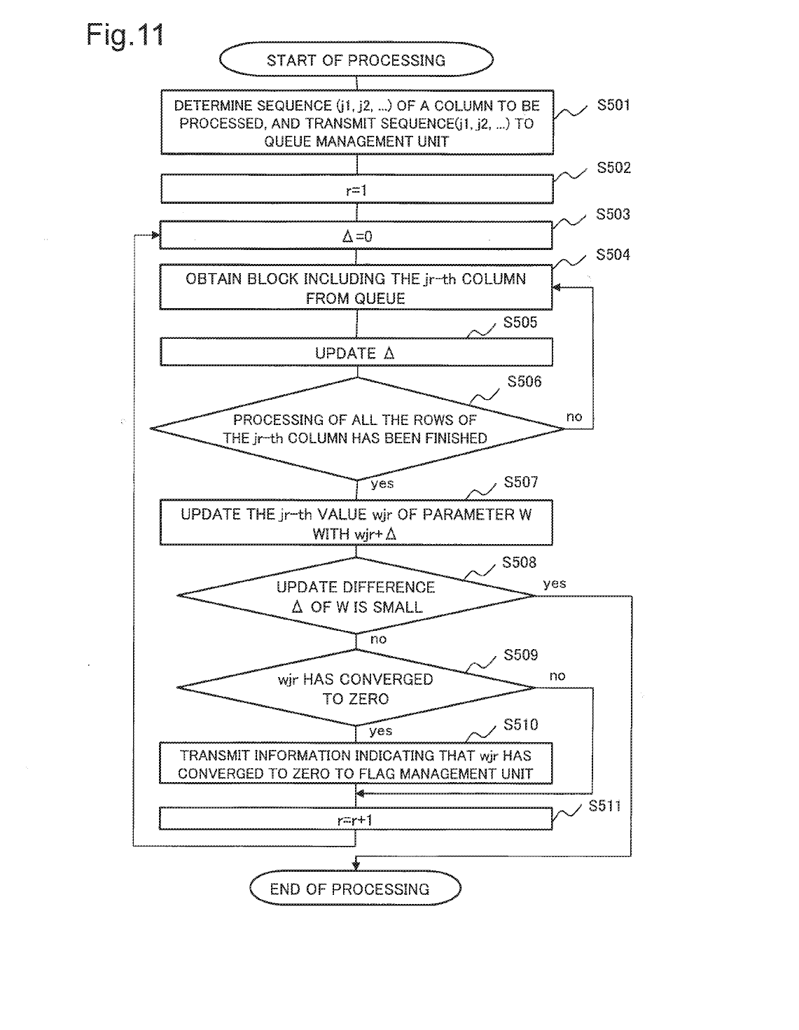

FIG. 11 is a flow diagram illustrating an operation of the repetition calculation unit 11 according to the third exemplary embodiment of the present invention. First, the repetition calculation unit 11 determines a sequence (j1, j2, . . . ) of a column to be processed, and transmits the sequence (j1, j2, . . . ) to the queue management unit 9 (step S501). The repetition calculation unit 11 initializes the counter r with one (step S502), and initializes the update difference Δ with zero (step S503). Subsequently, the repetition calculation unit 11 obtains a block including the jr-th column from the queue 8 (step S504), and updates the update difference Δ while reading the block row by row (step S505). The update difference Δ is calculated by, for example, adding a product xij×g(w) from the first row to the N-th row. Here, xij is a value of the i-th row and the j-th column (i is an integer equal to or more than one and equal to or less than N, and j is an integer equal to or more than one and equal to or less than M) of the training data having N rows and M columns (N, M are natural numbers), and g(w) is a function including w.

In a case where the processing of update of all the rows of the jr-th column of the block has not yet been finished (No in step S506), the repetition calculation unit 11 repeats the processing from step S504 to step S505 to process all the rows in the jr-th column of the block (returning back to step S504).

In a case where the processing of update of all the rows of the jr-th column of the block has been finished (YES in step S506), the repetition calculation unit 11 updates the jr-th component wjr (the jr-th column) of the parameter w of the objective function f(w) with wjr+Δ (step S507). In a case where the update difference Δ of the parameter w is smaller than a predetermined value (hereinafter descried as “sufficiently small”) (YES in step S508), the repetition calculation unit 11 terminates the operation (step processing). The predetermined value may be any value as long as it is a value indicating that the update difference Δ is sufficiently small, such as, e.g., 0.0001.

In a case where the update difference Δ of the parameter w is larger than the predetermined value (No in step S508), the repetition calculation unit 11 determines that there is still a room for update, and determines whether the component wjr has converged to zero or not (step S509). In a case where wjr has converged to zero (YES in step S509), the repetition calculation unit 11 transmits information indicating that wjr has converged to zero to the flag management unit 10 (step S510). Subsequently, the repetition calculation unit 11 updates the value of the counter r with r+1 (step S511), and repeats the above until the update difference Δ becomes sufficiently small (returning back to step S503).

In a case where the component wjr has not converted to zero (No in step S509), the repetition calculation unit 11 updates the value of the counter r with r+1 (step S511), and repeats the above until the update difference Δ becomes sufficiently small (returning back to step S503).

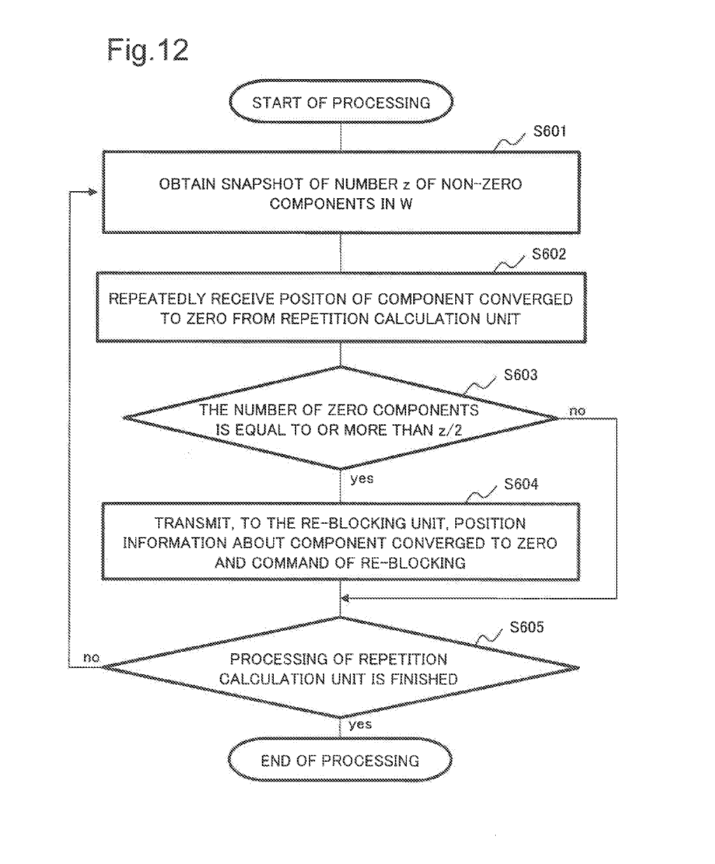

FIG. 12 is a flow diagram illustrating an operation of the flag management unit 10 according to the third exemplary embodiment of the present invention. As illustrated in FIG. 12, the flag management unit 10 manages, as a variable z, a snapshot of the number of non-zero components in the parameter w (step S601). Then, the flag management unit 10 repeatedly receives the position of a component converged to zero (step S602), and determines whether the number of pieces of position information about zero components received until then is equal to or more than z/2 (step S603). In a case where the number of pieces of position information about zero components is equal to or more than z/2 (YES in step S603), the flag management unit 10 transmits, to the re-blocking unit 4, position information about the component wjr converged to zero and a command of re-blocking (step S604). Then, in a case where the processing of the repetition calculation unit 11 is to be finished (YES in step S605), the processing of the flag management unit 10 is terminated.

In a case where the processing of the repetition calculation unit 11 is not to be finished (No in step S605), the flag management unit 10 repeats the above processing until the processing is finished (returning back to step S601). In a case where the number of pieces of position information about zero components is less than z/2 (No in step S603), the flag management unit 10 subsequently performs the processing in step S605. The denominator of z/2 may not be necessarily 2, and it may be parameterized so that a user can designate any given integer.

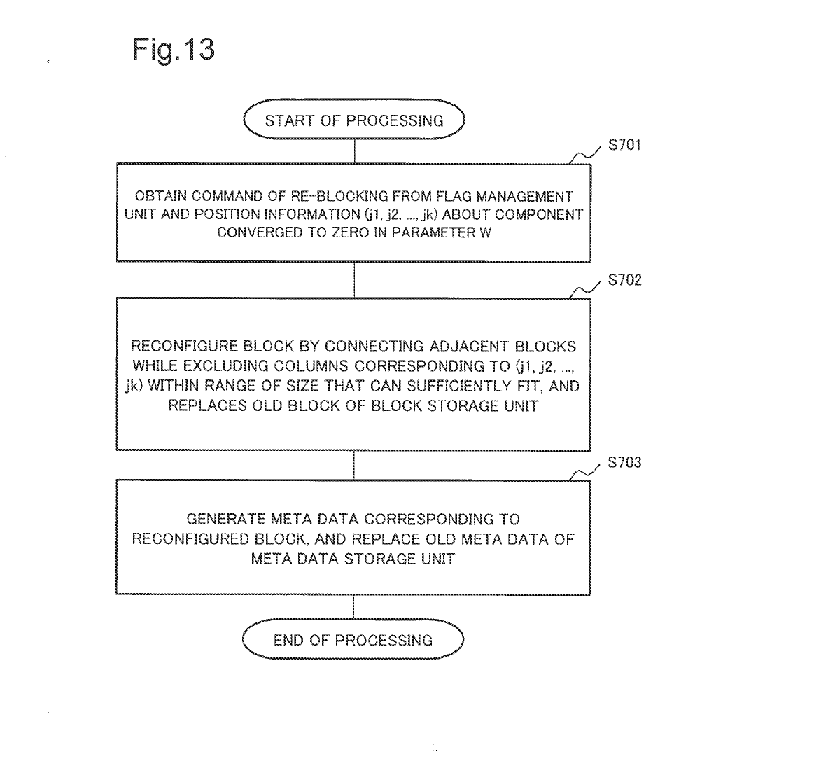

FIG. 13 is a flow diagram illustrating an operation of the re-blocking unit 4 according to the third exemplary embodiment of the present invention. As illustrated in FIG. 13, the re-blocking unit 4 obtains the command of re-blocking from the flag management unit 10 and the position information about the component converged to zero in the parameter w (step S701). Subsequently, the re-blocking unit 4 reconfigures the block by connecting adjacent blocks while excluding columns corresponding to components converged to zero within a range of a size that can sufficiently fit in the queue 8, and replaces the old block of the block storage unit 5 (step S702). For example, the re-blocking unit 4 reconfigures the block by connecting adjacent blocks while excluding columns corresponding to components converged to zero, and replaces the old block. Then, the re-blocking unit 4 generates meta data corresponding to the reconfigured block, and replaces the old meta data of the meta data storage unit 3 (step S703). The operation of the re-blocking unit 4 is finished as described above.

Subsequently, detailed operation of the data analysis apparatus 6 for carrying out the invention of the present application will be explained.

First, an example of operation for carrying out the blocking unit 2 of the data management apparatus 1 is shown with reference to FIG. 7. FIG. 7 is a figure illustrating an example of training data and block division thereof according to the third exemplary embodiment of the present invention.

A matrix having eight rows and eight columns as illustrated in FIG. 7 is an example of training data. For example, it is assumed that the queue 8 of the data analysis apparatus 6 can store only a data size of a half of the training data. The blocking unit 2 divides the training data into blocks having an appropriate size so that the maximum size of the block is equal to or less than the size of the queue 8. For example, the training data is equally divided in the row and column directions, and blocks are generated by equally dividing the training data into four as a whole.

As illustrated in FIG. 7, a dotted line described in the matrix having eight rows and eight columns represents a borderline of blocks. The blocks equally divided into four will be referred to as blocks 1, 2, 3, 4. In the block 1, for example, data in row x1 is “0.36 0.26 0.00 0.00”, and data in row x2 is “0.00 0.00 0.91 0.00”. In the block 1, data in row x3 is “0.01 0.00 0.00 0.00”, and data in row x4 is “0.00 0.00 0.09 0.00”.

The method for dividing blocks is not limited to this example. For example, only row or column direction may be divided, or division can be made so that the size differs for each block, or division can be made upon sorting rows and columns in accordance with any method in advance.

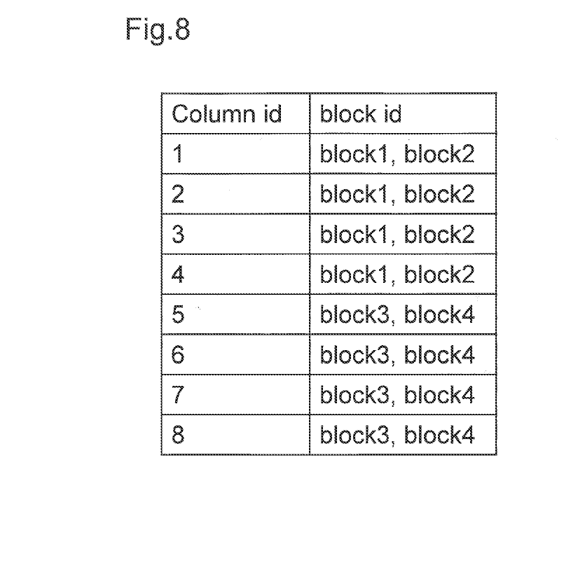

The blocking unit 2 divides blocks, and calculates meta data of the blocks at the same time. FIG. 8 is a figure illustrating an example of meta data according to the third exemplary embodiment of the present invention. FIG. 8 illustrates meta data of the four blocks of FIG. 7, for example. More specifically, each row of the meta data indicates which block each column of the training data is distributed to. As illustrated in FIG. 8, for example, the first row of the meta data indicates that the value corresponding to the first column in the training data is distributed to the blocks 1 and 2.

The format of the meta data is not limited to this example, and any format can be employed as long as it includes information indicating which block the value of the training data belongs to.

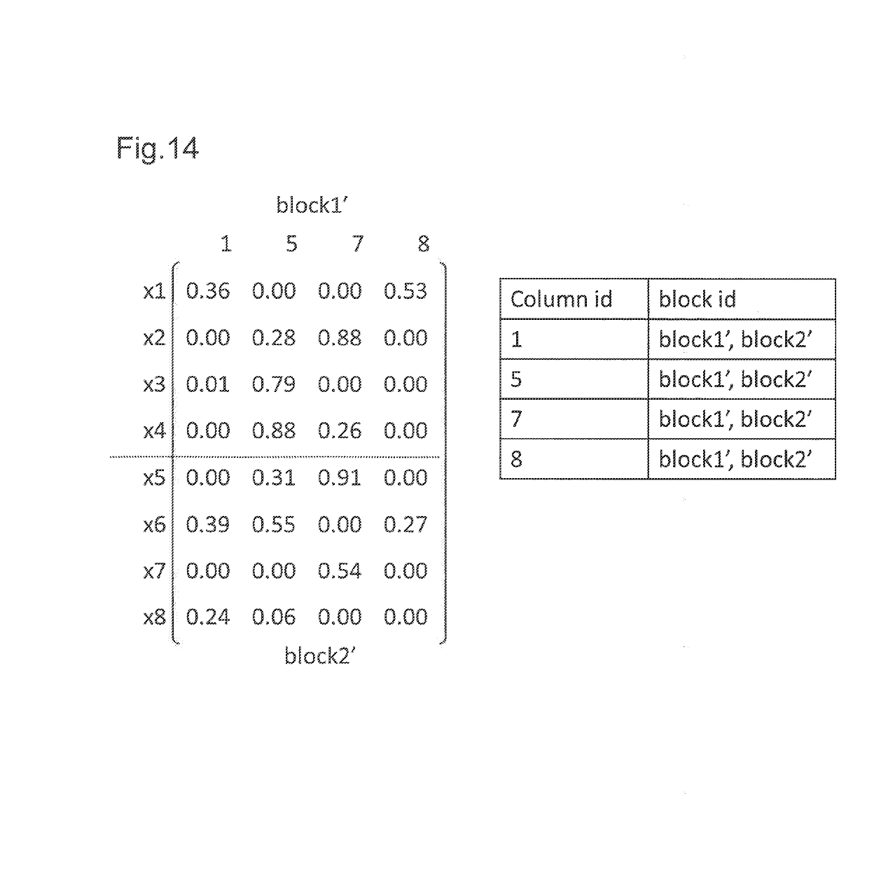

Subsequently, a specific example of operation about re-blocking will be explained with reference to FIG. 7 and FIG. 14.

While the data analysis apparatus 6 reads blocks to the queue 8 in order, the repetition calculation unit 11 performs optimization of the parameter w. In a case that the initial value of the parameter w is randomly determined to be (1, 10, 2, 3, 4, 8, 3) and then the optimization is started, for example, the number z of non-zero components managed by the flag management unit 10 is 8. In a case where the repetition calculation unit 11 determines that the component of the second column of the parameter w converges to zero after several repeated calculations, the flag management unit 10 stores the position information about the second column. Further, the repeated calculations are further performed, and it is assumed that the third, fourth, and sixth columns have also converged to zero. Likewise, the flag management unit 10 also stores position information about the third, fourth, and sixth columns. Further, since components as many as the number equal to or more than z/2 have converged to zero, the flag management unit 10 transmits the position information (2, 3, 4, 6) and a re-blocking command to the re-blocking unit 4 of the data management apparatus 1.

The re-blocking unit 4 having received the command performs re-blocking of the blocks in the block storage unit 5 so as to attain a size that can be sufficiently fit in the queue 8 while excluding the columns of the received position information (2, 3, 4, 6).

FIG. 14 is a figure illustrating an example of new blocks generated in the re-blocking and meta data according to the third exemplary embodiment of the present invention. FIG. 14 is an example where four blocks as illustrated in FIG. 7 are re-blocked on the basis of the position information (2, 3, 4, 6). In this case, two blocks are generated while the second, third, fourth, and sixth columns are excluded, and the old blocks (FIG. 7) of the block storage unit 5 are replaced. Then, as illustrated in FIG. 14, new meta data (the drawing at the right hand side of FIG. 14) is generated from new blocks (the drawing at the left hand side of FIG. 14).

By excluding the unnecessary columns from the blocks, the ratio of the blocks that are read to the queue 8 increases with respect to all of the blocks, and there is an advantage in that required information is more easily stored in a buffer or a cache.

As described above, in the data analysis system 103 according to the third exemplary embodiment of the present invention, the blocking unit 2 of the data management apparatus 1 reads the training data stored in the training data storage unit 12, divides the training data into blocks, and stores the blocks to the block storage unit 5. The blocking unit 2 generates meta data indicating for which row and which column each block holds the value of the original training data, and stores the meta data to the meta data storage unit 3. On the basis of the position information about the component of the parameter converged to zero during the repeated calculations, the re-blocking unit 4 re-configures the blocks so as to exclude columns corresponding to that position in the training data, replaces the old blocks, and holds the blocks.

The data analysis apparatus 6 includes a parameter storage unit 7, a queue 8, a queue management unit 9, a flag management unit 10, and a repetition calculation unit 11. The parameter storage unit 7 stores a variable, which is to be updated, such as a parameter. The queue 8 stores a block. The repetition calculation unit 11 reads, from the queue 8, a block or representing value required for the column to be calculated by the repetition calculation unit 11, and performs update calculation. The repetition calculation unit 11 carries out the repeated calculations according to the CD method while reading predetermined blocks stored in the queue 8. The queue management unit 9 discards the unnecessary blocks from the queue 8, and obtains newly needed blocks from the block storage unit 5. The flag management unit 10 receives information indicating that the component wj has converged to zero from the repetition calculation unit 11, and outputs the unnecessary columns to the data management apparatus 1. Therefore, the data analysis system 103 can use the CD method even in circumstances where the size of training data is more than the memory size of or the calculator, and can reduce the processing time of the CD method under such circumstances.

The reason for this is as follows. More specifically, the training data is divided into blocks, and processing is performed in blocks, so that even in a case where the training data cannot fit in the memory, the processing of the CD method can be executed. Some of the components of the parameter sometimes converge to zero during the repeated calculations based on optimization. The parameter component converged to zero does not change in the subsequent repeated calculations. More specifically, it is not necessary to read the data columns corresponding to the components after that point in time. The data columns that are not required to be read are removed in the re-blocking, so that many required data columns can be read at a time, and therefore, the calculation can be performed in a short time.

In order to specifically explain the mechanism for shortening the calculation, the CD method using the training data as illustrated in FIG. 7 will be considered. The training data is read from a secondary storage device to a main storage device to be processed. However, for example, the calculator is considered to be able to read only a half of the training data to the main storage at a time because of the problem in the capacity. A method for reading every four rows of training data to the main storage and process the training data can be considered as a countermeasure used at this occasion. More specifically, in order to perform update of the component wj in the column j, the first row to the fourth row are read and processed, and subsequently, the fifth row to the eighth row are read and processed. In this case, IO occurs two times. Where the update calculation of the first column to the eighth column is considered to be performed in each of repeated calculations, IO occurs sixteen times. If the first, second, third, and fourth components of the parameter w converge to zero at the time the calculation has been repeated 50 times, and the parameter w is optimized at the time the calculation has been repeated 100 times, IO occurs totally 2×8×50+2×4×50=1200 times.

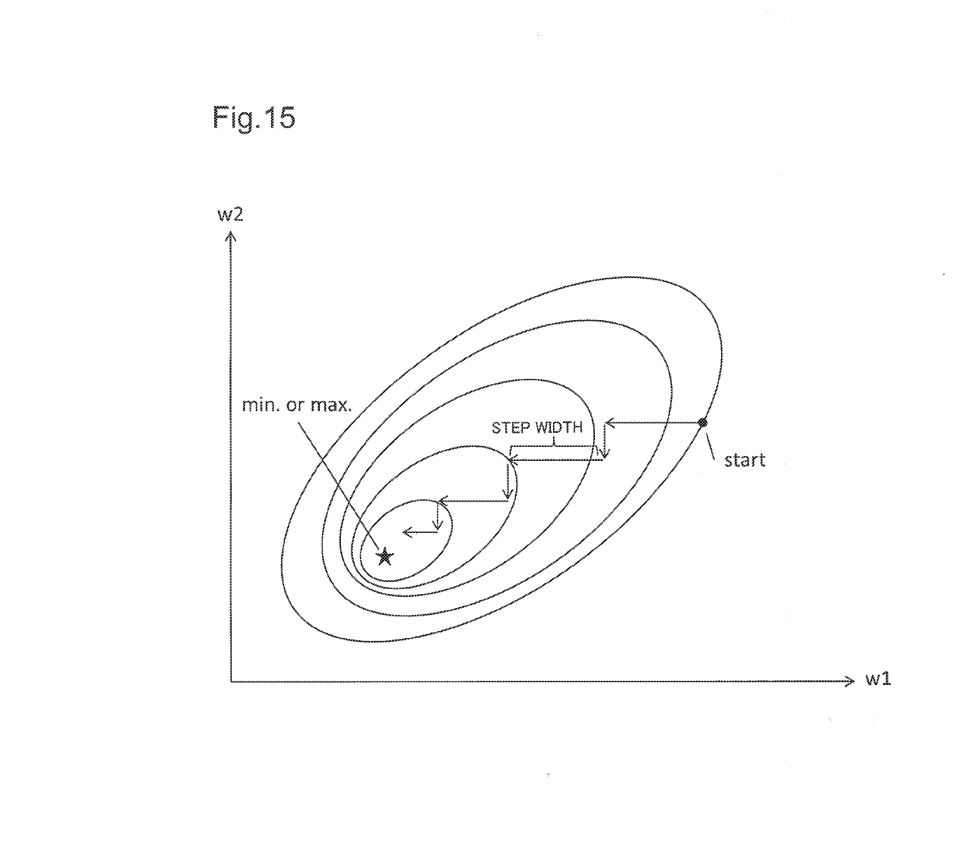

In this case, at the time the calculation has been repeated 50 times, the first to fourth columns in the training data are not referred to again. This is because of the following. As described above, in the calculation for the column j according to the CD method, the component wj of the parameter w is updated with wj+α·d. Here, d denotes a movement direction at a start point in FIG. 15, and α denotes a movement width (step width). α·d is a value obtained from a total summation of a product xij×g(w) in the i-th row. Here xij is a value in the i-th row and the j-th column of the training data and g(w) is a function including w. The value of the j-th column of the training data is used only for the update of wj.

Therefore, when the training data on the secondary storage device is replaced with the training data from which the first to the fourth columns are removed, the data size becomes half. Therefore, in the 51-st to the 100-th repeated processing, the replaced data may be read once. In this case, IO occurs totally 2×8×50+1×4×50=1000 times, and the number of times the IO is performed is less than that of a case where the replacing is not performed.

Therefore, there is an effect in that the entire processing time can be reduced.

While the invention has been particularly shown and described with reference to exemplary embodiments thereof, the invention is not limited to these embodiments. It will be understood by those of ordinary skill in the art that various changes in form and details may be made therein without departing from the scope of the present invention as defined by the claims.

The whole or part of the exemplary embodiments disclosed above can be described as, but not limited to, the following supplementary notes.

[Supplementary Note 1]

A data management apparatus including:

a blocking unit which divides training data representing matrix data into a plurality of blocks, and generating meta data indicating a column for which each block holds a value of the original training data; and

a re-blocking unit which, when a component of a parameter learned from the training data converges to zero, replaces an old block including an unnecessary column, among the plurality of blocks, with a block from which the unnecessary column has been removed, and regenerates the meta data.

[Supplementary Note 2]

The data management apparatus according to Supplementary Note 1, wherein

the re-blocking unit reconfigures a block by connecting adjacent blocks of the plurality of blocks while excluding a column corresponding to a component converged to zero from among columns included in the blocks.

[Supplementary Note 3]

The data management apparatus according to Supplementary Note 2 further including a meta data storage unit which stores the meta data, wherein

the re-blocking unit generates meta data corresponding to the reconfigured block, and updates the meta data stored in the meta data storage unit.

[Supplementary Note 4]

A data management method including:

dividing training data representing matrix data into a plurality of blocks, and generating meta data indicating a column for which each block holds a value of the original training data; and

when a component of a parameter learned from the training data converges to zero, replacing an old block including an unnecessary column, among the plurality of blocks, with a block from which the unnecessary column has been removed, and regenerating the meta data.

[Supplementary Note 5]

A program, causing a computer to perform a method including:

dividing training data representing matrix data into a plurality of blocks, and generating meta data indicating a column for which each block holds a value of the original training data; and

when a component of a parameter learned from the training data converges to zero, replacing an old block including an unnecessary column, among the plurality of blocks, with a block from which the unnecessary column has been removed, and regenerating the meta data.

[Supplementary Note 6]

A data analysis apparatus including:

a queue management unit which reads a predetermined block from among a plurality of blocks which are obtained by dividing training data representing matrix data, and stores the predetermined block to a queue;

a repetition calculation unit which reads the predetermined block stored in the queue, and carries out repeated calculations according to a CD method; and

a flag management unit which, when a component of a parameter converges to zero during each of the repeated calculations, transmits a flag indicating that a column of the training data corresponding to the component converged to zero can be removed.

[Supplementary Note 7]

The data analysis apparatus according to Supplementary Note 6, wherein

the repetition calculation unit determines whether each component of the parameter converges to zero or not for each of the repeated calculations, and in a case where the repetition calculation unit determines that there is a component converged to zero, the repetition calculation unit notifies the flag management unit of the component converged to zero.

[Supplementary Note 8]

The data analysis apparatus according to Supplementary Note 6 or 7, wherein

in a case where at least one component included in the predetermined block is updated, the repetition calculation unit further updates the component when an update difference of the updated component is more than a predetermined threshold value.

[Supplementary Note 9]

The data analysis apparatus according to any one of Supplementary Notes 6 to 8, wherein

the queue management unit discards a block which is unnecessary as a result of the repeated calculations according to the CD method, from the queue, and stores a newly needed block to the queue.

[Supplementary Note 10]

The data analysis apparatus according to any one of Supplementary Notes 6 to 9, wherein

the queue management unit identifies a block on which the repetition calculation unit has not carried out the repeated calculations according to the CD method from among the plurality of blocks, and reads the identified block as the predetermined block.

[Supplementary Note 11]

The data analysis apparatus according to any one of Supplementary Notes 6 to 10, wherein

the flag management unit receives information about a component converged to zero from among the components of the parameter from the repetition calculation unit, and transmits a flag indicating that a column of training data corresponding to the component converged to zero can be removed.

[Supplementary Note 12]

The data analysis apparatus according to any one of Supplementary Notes 6 to 11, wherein

the flag management unit determines whether the number of components converged to zero from among components of the parameter is equal to or more than a predetermined number or not, and requests re-blocking of the plurality of blocks when the number of components converged to zero is equal to or more than the predetermined number.

[Supplementary Note 13]

A data analysis method including:

reading a predetermined block from among a plurality of blocks which are obtained by dividing training data representing matrix data, and storing the predetermined block to a queue;

reading the predetermined block stored in the queue, and carrying out repeated calculations according to a CD method; and

when a component of a parameter converges to zero during each of the repeated calculations, transmitting a flag indicating that a column of the training data corresponding to the component converged to zero can be removed.

[Supplementary Note 14]

A program, causing a computer to perform a method including:

reading a predetermined block from among a plurality of blocks which are obtained by dividing training data representing matrix data, and storing the predetermined block to a queue;

reading the predetermined block stored in the queue, and carrying out repeated calculations according to a CD method; and

when a component of a parameter converges to zero during each of the repeated calculations, transmitting a flag indicating that a column of the training data corresponding to the component converged to zero can be removed.

[Supplementary Note 15]

A data analysis system including:

a blocking unit which divides training data representing matrix data into a plurality of blocks, and generating meta data indicating a column for which each block holds a value of the original training data;

a re-blocking unit which, when a component of a parameter learned from the training data converges to zero, replaces an old block including an unnecessary column, among the plurality of blocks, with a block from which the unnecessary column has been removed, and regenerates the meta data;

a queue management unit which reads a predetermined block from among the plurality of blocks which are obtained by dividing the training data representing matrix data, and stores the predetermined block to a queue;

a repetition calculation unit which reads the predetermined block stored in the queue, and carries out repeated calculations according to a CD method; and

a flag management unit which, when a component of a parameter converges to zero during each of the repeated calculations, transmits a flag indicating that a column of the training data corresponding to the component converged to zero can be removed.

[Supplementary Note 16]

The data analysis system according to Supplementary Note 15, wherein

the re-blocking unit reconfigures a block by connecting adjacent blocks of the plurality of blocks while excluding a column corresponding to a component converged to zero from among columns included in the blocks.

[Supplementary Note 17]

The data analysis system according to Supplementary Note 16 further including a meta data storage unit which stores the meta data, wherein

the re-blocking unit generates meta data corresponding to the reconfigured block, and updates the meta data stored in the meta data storage unit.

[Supplementary Note 18]

The data analysis system according to Supplementary Note 15, wherein

the repetition calculation unit determines whether each component of the parameter converges to zero or not for each of the repeated calculations, and in a case where the repetition calculation unit determines that there is a component converged to zero, the repetition calculation unit notifies the flag management unit of the component converged to zero.

[Supplementary Note 19]

The data analysis system according to Supplementary Note 15 or 16, wherein

in a case where at least one component included in the predetermined block is updated, the repetition calculation unit further updates the component when an update difference of the updated component is more than a predetermined threshold value.

[Supplementary Note 20]

The data analysis system according to any one of Supplementary Notes 15 to 17, wherein

the queue management unit discards a block which is unnecessary as a result of the repeated calculations according to the CD method, from the queue, and stores a newly needed block to the queue.

[Supplementary Note 21]

The data analysis system according to any one of Supplementary Notes 15 to 18, wherein

the queue management unit identifies a block on which the repetition calculation unit has not carried out the repeated calculations according to the CD method from among the plurality of blocks, and reads the identified block as the predetermined block.

[Supplementary Note 22]

The data analysis system according to any one of Supplementary Notes 15 to 19, wherein

the flag management unit receives information about a component converged to zero from among the components of the parameter from the repetition calculation unit, and transmits a flag indicating that a column of training data corresponding to the component converged to zero can be removed.

[Supplementary Note 23]

The data analysis system according to any one of Supplementary Notes 15 to 20, wherein

the flag management unit determines whether the number of components converged to zero from among components of the parameter is equal to or more than a predetermined number or not, and requests re-blocking of the plurality of blocks when the number of components converged to zero is equal to or more than the predetermined number.

[Supplementary Note 24]

An analysis method including:

dividing training data representing matrix data into a plurality of blocks, and generating meta data indicating a column for which each block holds a value of the original training data;

when a component of a parameter learned from the training data converges to zero, replacing an old block including an unnecessary column, among the plurality of blocks, with a block from which the unnecessary column has been removed, and regenerating the meta data;

reading a predetermined block from among the plurality of blocks which are obtained by dividing the training data representing matrix data, and storing the predetermined block to a queue;

reading the predetermined block stored in the queue, and carrying out repeated calculations according to a CD method; and

when a component of a parameter converges to zero during each of the repeated calculations, transmitting a flag indicating that a column of the training data corresponding to the component converged to zero can be removed.

[Supplementary Note 25]

A program, causing a computer to perform a method including:

dividing training data representing matrix data into a plurality of blocks, and generating meta data indicating a column for which each block holds a value of the original training data;

when a component of a parameter learned from the training data converges to zero, replacing an old block including an unnecessary column, among the plurality of blocks, with a block from which the unnecessary column has been removed, and regenerating the meta data;

reading a predetermined block from among the plurality of blocks which are obtained by dividing the training data representing matrix data, and storing the predetermined block to a queue;

reading the predetermined block stored in the queue, and carrying out repeated calculations according to a CD method; and

when a component of a parameter converges to zero during each of the repeated calculations, transmitting a flag indicating that a column of the training data corresponding to the component converged to zero can be removed.

This application is based upon and claims the benefit of priority from Japanese patent application No. 2014-028454, filed on Feb. 18, 2014, the disclosure of which is incorporated herein in its entirety by reference.

### REFERENCE SIGNS LIST

1 data management apparatus
2 blocking unit
3 meta data storage unit
4 re-blocking unit
5 block storage unit
6 data analysis apparatus
7 parameter storage unit
8 queue
9 queue management unit
10 flag management unit
11 repetition calculation unit
12 training data storage unit
13 network
20 blocking unit
21 CPU
22 RAM
23 storage device
24 communication interface
25 input apparatus
26 output apparatus
40 re-blocking unit
90 queue management unit
100 flag management unit
101 data management apparatus
102 data analysis apparatus
103 data analysis system
110 repetition calculation unit

1. A data management apparatus comprising:
a blocking unit which divides training data representing matrix data into a plurality of blocks, and generating meta data indicating a column for which each block holds a value of the original training data; and
a re-blocking unit which, when a component of a parameter learned from the training data converges to zero, replaces an old block including an unnecessary column, among the plurality of blocks, with a block from which the unnecessary column has been removed, and regenerates the meta data.

2. The data management apparatus according to claim 1, wherein
the re-blocking unit reconfigures a block by connecting adjacent blocks of the plurality of blocks while excluding a column corresponding to a component converged to zero from among columns included in the blocks.

3. A data analysis apparatus comprising:
a queue management unit which reads a predetermined block from among a plurality of blocks which are obtained by dividing training data representing matrix data, and stores the predetermined block to a queue;
a repetition calculation unit which reads the predetermined block stored in the queue, and carries out repeated calculations according to a CD method; and
a flag management unit which, when a component of a parameter converges to zero during each of the repeated calculations, transmits a flag indicating that a column of the training data corresponding to the component converged to zero can be removed.

4. The data analysis apparatus according to claim 3, wherein
the repetition calculation unit determines whether each component of the parameter converges to zero or not for each of the repeated calculations, and in a case where the repetition calculation unit determines that there is a component converged to zero, the repetition calculation unit notifies the flag management unit of the component converged to zero.

5. (canceled)

6. (canceled)

7. (canceled)

8. A data management method comprising:
dividing training data representing matrix data into a plurality of blocks, and generating meta data indicating a column for which each block holds a value of the original training data; and
when a component of a parameter learned from the training data converges to zero, replacing an old block including an unnecessary column, among the plurality of blocks, with a block from which the unnecessary column has been removed, and regenerating the meta data.

9. (canceled)

10. (canceled)

11. The data management apparatus according to claim 2 further comprising a meta data storage unit which stores the meta data, wherein
the re-blocking unit generates meta data corresponding to the reconfigured block, and updates the meta data stored in the meta data storage unit.

12. The data analysis apparatus according to claim 3, wherein
in a case where at least one component included in the predetermined block is updated, the repetition calculation unit further updates the component when an update difference of the updated component is more than a predetermined threshold value.

13. The data analysis apparatus according to claim 3, wherein
the queue management unit discards a block which is unnecessary as a result of the repeated calculations according to the CD method, from the queue, and stores a newly needed block to the queue.

14. The data analysis apparatus according to claim 3, wherein
the queue management unit identifies a block on which the repetition calculation unit has not carried out the repeated calculations according to the CD method from among the plurality of blocks, and reads the identified block as the predetermined block.

15. The data analysis apparatus according to claim 3, wherein
the flag management unit receives information about a component converged to zero from among the components of the parameter from the repetition calculation unit, and transmits a flag indicating that a column of training data corresponding to the component converged to zero can be removed.

16. The data analysis apparatus according to claim 3, wherein
the flag management unit determines whether the number of components converged to zero from among components of the parameter is equal to or more than a predetermined number or not, and requests re-blocking of the plurality of blocks when the number of components converged to zero is equal to or more than the predetermined number.
